(19) United States
(12) Patent Application Publication
(10) Pub. No.: US 2011/0239444 A1
(43) Pub. Date: Oct. 6, 2011

(54) Method of Manufacturing Lapping Plate, and Method of Manufacturing Magnetic Head Slider using the Lapping Plate

(75) Inventors: Nobuhiko FUKUOKA, Hiratsuka (JP); Hiroyuki Kojima, Yokohama (JP); Shinji Sasaki, Yokohama (JP); Toshio Tamura, Yokohama (JP)

(73) Assignee: Hitachi, Ltd., Tokyo (JP)

(21) Appl. No.: 13/020,037

(22) Filed: Feb. 3, 2011

(30) Foreign Application Priority Data
Mar. 31, 2010 (JP) 2010-080099

(51) Int. Cl. G11B 5/84; B24D 18/00; B24D 3/00

(52) U.S. Cl. 29/603.16; 51/295

(57) ABSTRACT

A method of manufacturing a lapping plate which has abrasive grains fixed in the plate and which is used for lapping of the air bearing surface of a magnetic head. Abrasive grains fixed in the lapping plate are subjected to an abrasive digging process to selectively lap the surface of the lapping plate in the vicinity of the abrasive grains, and the dug abrasive grains are subjected to an equalization process to make their abrasive grain heights equal.

### INCORPORATION BY REFERENCE

The present application claims priority from Japanese application JP2010-080099 filed on Mar. 31, 2010, the content of which is hereby incorporated by reference into this application.

### BACKGROUND OF THE INVENTION

The present invention relates to a method of manufacturing a lapping plate having diamond abrasive grains fixed therein and also a method of manufacturing a magnetic head slider using the lapping plate.

In these years, as the quantity of information handled by a magnetic disk device is increased, a demand of a higher recording density to the disk became rapidly strong. In order to serve the demand, it becomes vital to increase a detection sensitivity for a signal when recorded information is read out from or written in a magnetic recording medium of a magnetic head and also to increase the output of the signal by further reducing a flying height for the magnetic recording medium. In order to further reduce the flying height, it becomes indispensable to process the air bearing surface of the magnetic head positioned to face the rotating magnetic recording medium so as to attain a smoother surface.

In a method of manufacturing a magnetic head, in general, the magnetic head is manufactured by sequentially laminating an insulating layer, a magnetic read element, a magnetic write element, and an overcoat on a ceramic substrate made of Al₂O₃—TiC (alumina titanium carbide) or the like by a thin film process based on a lithography technique. Next, a strip piece (which will be referred to row bar, hereinafter) in the form of a plurality of structures connected continuously to each other, is cut out from the substrate by using a dicer or the like. The structures will be later made as a magnetic head including a magnetic write element and a magnetic read element. Strains or stresses left after the cutting are removed by a method such as a double side lapping method, and then the surface (air bearing surface) to be opposed to the magnetic recording medium is lapped at a high accuracy. Thereafter, after an overcoat such as a DLC (Diamond-Like-Carbon) film is formed on the air bearing surface, a rail shape is formed on the air bearing surface, for example, by ion milling to float the magnetic head from the surface of the magnetic recording medium. Small pieces (sliders) including the magnetic write element and the magnetic read element are individually cut out from the row bar to complete a magnetic head.

A process of lapping the row bar generally includes a rough lapping step and a fine lapping step of reducing and minimizing a surface roughness. The rough lapping is carried out usually by pushing and sliding the row bar fixed to a lapping tool while dropping a lapping slurry with abrasive grains of diamond or the like on a rotating lapping plate made of a soft-metal based material. The fine lapping is carried out by pushing and sliding a short strip piece fixed to the lapping tool while dropping the lapping slurry without abrasive grains on a lapping plate having abrasive grains of diamond or the like previously fixed therein. In some cases, even for the rough lapping, a lapping plate having abrasive grains which have a size larger than the size of grains used for the fine lapping and which are fixed therein may be used.

In the rough lapping step, dimension control of bringing the heights of the magnetic write or read elements within a specified range is carried out by partially adjusting a pressure applied to the row bar and processing the bar while detecting the resistance values of the magnetic write or read elements or detecting the resistance value of an ELG (Electric Lapping Guide) element separately provided.

A method of fixing abrasive grains in the lapping plate is disclosed in JPA-2007-253274. That is, while a diamond slurry is supplied on a rotating lapping plate and a fixing tool is rotated, diamond abrasive grains are pushed against the surface of the plate to be fixed in the plate. Thereafter, abrasive grains not fixed in the lapping plate and remaining on the surface of the lapping plate are removed by cleaning the plate, thus completing a lapping plate having abrasive grains fixed therein.

### SUMMARY OF THE INVENTION

In the aforementioned row bar lapping step, one of large factors dominating the surface roughness of the air bearing surface is a cutting depth by abrasive grains with respect to the surface of the row bar, and the surface roughness is influenced by, in particular, an abrasive grain height fixed in the lapping plate as a tool and an abrasive grain height variation. The abrasive grain height is influenced by the lapping rate of the row bar.

In the abrasive grain fixing method disclosed in JP-A-2007-253274, the abrasive grain height and the abrasive grain height variation in a state immediately after the abrasive grain fixing are large. This means that, as the lapping quantity increases, the abrasive grains are pushed more into the lapping plate, thereby making abrasive grain heights become uniform. In other words, when a lapping load is always constant, as the lapping quantity increases, the lapping rate tends to be decreased and the surface roughness of the air bearing surface also tends to be correspondingly decreased. However, when the lapping rate becomes extremely small, a lapping time until a flat and smooth air hearing surface is achieved becomes abnormally long, which leads to a serious harm in the productivity of the magnetic head element itself.

In the aforementioned contradictory relationship between the lapping rate and the surface roughness of the air bearing surface in the prior art, it is demanded to lap the air bearing surface of the magnetic head into a desired shape at an efficiency as high as possible and in a time as short as possible.

In order to solve the above object, the present invention is arranged to fix first abrasive grains in a lapping plate and then remove metal particles present in the vicinity of first embedded abrasive grains (fixed abrasive grains) by supplying second abrasive grains onto the lapping plate and also by pushing the supplied second abrasive grains against the surface of the lapping plate using an unwoven cloth or the like having an irregular surface. This step will be referred to as an abrasive digging process, hereinafter.

Thereafter, variations in the abrasive grain height of the first abrasive grains embedded or fixed in the lapping plate are made small by pushing a ceramic substrate or the like against the lapping plate subjected to the above abrasive digging process with an adjusted pressure. This will be referred to as an abrasive peak equalization process, hereinafter.

A magnetic head element is manufactured in accordance with such a procedure as given below with use of the lapping plate subjected to the above abrasive digging process and the abrasive peak equalization process. More specifically, a thin film magnetic head is completed through steps of forming a plurality of magnetic write and read elements and an overcoat on a ceramic substrate; cutting the ceramic substrate into row bars; lapping a surface of the row bar as an air bearing surface by pushing and sliding the surface of the row bar against a rotating lapping plate of a soft metal based material, on which a lapping slurry with abrasive grains of diamond or the like is dropped, or against a lapping plate, in which abrasive grains of an average grain size larger than the average grain size of abrasive grains used in the next fine lapping step are embedded or fixed therein and on which a lapping slurry without abrasive grains is dropped; lapping the same surface of the row bar by pushing and sliding the same surface of the row bar against the lapping plate obtained through the above abrasive digging process and the abrasive peak equalization process; forming an overcoat on the surface of the lapped row bar; forming an air bearing surface rail on the surface of the row bar having an overcoat formed thereon; and cutting the row bar into individual thin film magnetic heads each including the magnetic write and read elements.

Since a lapping plate is manufactured through the abrasive digging process using an unwoven cloth or the like having an irregular surface and through the subsequent abrasive peak equalization process using a ceramic substrate or the like; there is obtained a lapping plate which has a large abrasive grain height and a small height variation, or in other words, which can maintain a smooth lapping surface to a lapping target over a long period of time.

Other objects, features and advantages of the invention will become apparent from the following description of the embodiments of the invention taken in conjunction with the accompanying drawings.

### BRIEF DESCRIPTION OF THE DRAWINGS

FIG. 1 is a schematic diagram for explaining abrasive digging process in the present invention;

FIGS. 2A and 2B are diagrams for explaining a relationship between an average abrasive grain height of first abrasive grains and an abrasive grain height variation after an abrasive grain fixing process is carried out, wherein FIG. 2A is a state before the abrasive digging process is carried out and FIG. 2B is a state after the abrasive digging process is carried out;

FIG. 3 shows a relationship between an abrasive digging process time in the abrasive digging process and a change in the average abrasive grain height in the present invention;

FIG. 4 is a diagram for explaining a conditioning tool for performing the abrasive peak equalization process in the present invention;

FIGS. 5A and 5B are diagrams for explaining the abrasive peak equalization process in the present invention, wherein FIG. 5A is an entire schematic diagram and FIG. 5B is an enlargement thereof showing a relationship between a lapping plate and a ceramic substrate;

FIG. 6 is a schematic diagram for explaining an abrasive grain height and a variation therein after the abrasive peak equalization process in the present invention;

FIG. 7 is a graph showing a relationship between an average abrasive grain height and an abrasive grain height variation in a lapping plate having first abrasive grains fixed therein, when the abrasive digging process and the abrasive peak equalization process therefor are not carried out;

FIG. 8 is a graph showing a relationship an average abrasive grain height of first abrasive grains and a variation thereof in a lapping plate after the first abrasive grains are fixed therein and then subjected to the abrasive digging process and the abrasive peak equalization process;

FIG. 9 shows steps for explaining a method of manufacturing a magnetic head in accordance with the present invention; and

FIG. 10 is a graph showing a relationship between an air bearing surface roughness and a fine lapping rate in a magnetic head element when manufactured with use of the lapping plate of the present invention.

### DESCRIPTION OF THE EMBODIMENTS

An embodiment of the present invention will be explained in detail with reference to accompanying drawings.

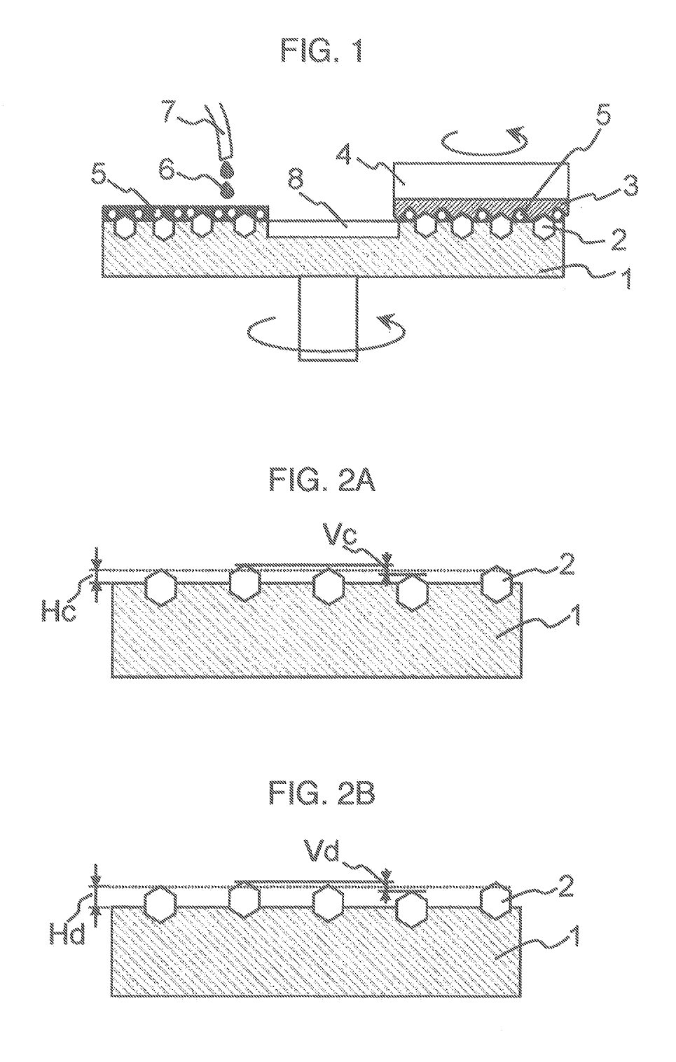

FIG. 1 is a schematic diagram for explaining an abrasive digging process in the present invention. In FIG. 1, diamond abrasive grains 2 (which will be referred to as first abrasive grains, hereinafter, unless otherwise stated) are embedded and fixed in one surface of a lapping plate 1 using an abrasive grain fixing tool already known in the art. A recess 8 is formed in the center of the lapping plate 1, and a hole (not shown) for discharging a lapping lubricant 6 supplied to the recess 8 is provided in the recess 8.

While the lapping lubricant 6 with abrasive grains 5 (which will be referred to as second abrasive grains, hereinafter unless otherwise stated) is supplied from a supply tube 7 onto the surface of the lapping plate 1, a dressing tool 4 having an unwoven cloth 3 applied to its surface is rotated and pushed against the surface of the lapping plate 1. As a result, under the dressing tool 4, a part of a metallic surface of the lapping plate 1 that has no diamond abrasive grains 2 embedded or fixed therein is processed by the abrasive grains 5 by virtue of the unwoven cloth 3. Thus the abrasive grain height of the diamond abrasive grains 2 already fixed in the lapping plate 1 can be increased by processing the metallic surface of the lapping plate 1 with use of the unwoven cloth 3.

The unwoven cloth 3 is required to have a function of pushing the abrasive grains 5 against the surface of the lapping plate 1 without being disturbed by the diamond abrasive grains 2 fixed in the plate. To this end, the unwoven cloth 3 is required to have an irregular surface or to have an elastically deformed surface when the surface of the unwoven cloth is pushed against the plate. As an example of the material of the unwoven cloth, an urethane immersed unwoven cloth, a foamed polyurethane material or a suede may be used.

As the lapping lubricant 6, such a liquid that contains a dispersant, a surfactant or the like so as to be able to maintain a state in which the abrasive grains 5 are dispersed, is used. In order to cause the abrasive grains 5 to enter into gaps between the fixed diamond abrasive grains 2, it is preferable that the abrasive grains 5 supplied onto the lapping plate 1 together with the lapping lubricant 6 have an average grain size nearly the same as or not larger than the average grain size of the diamond abrasive grains 2. The material of the abrasive grains 5 is only required to be able to process the surface of the lapping plate 1 made of a soft metal material (tin, alloy thereof or the like). As an example, the material of the abrasive grains 5 may be diamond of the same material as the diamond abrasive grains 2, silicon carbide, alumina or a mixture thereof.

FIGS. 2A and 2B are diagrams for explaining an abrasive digging process for abrasive grains 2 fixed in the lapping plate 1 after the diamond abrasive grains 2 are fixed in the lapping plate 1, as one of features of the present invention. FIG. 2A is a schematic diagram for explaining a relationship between average abrasive grain height and abrasive grain height variation for the abrasive grains before the abrasive digging process is carried out. In FIGS. 2A and 2B, Hc denotes an average abrasive grain height of the diamond abrasive grains 2 after the abrasive grain fixing process, and Vc denotes an abrasive grain height variation. As the abrasive grain fixing process proceeds, the diamond abrasive grains 2 kept or held in the lapping plate 1 at the initial stage of the abrasive grain fixing process are indented into the surface of the lapping plate 1, and thus the abrasive grain height becomes gradually low. This means that, even when the diamond abrasive grains 2 have a large initial average grain size, the abrasive grain height of the abrasive grains is decreased as the diamond abrasive grains 2 are embedded excessively, which results in that a large lapping rate cannot be obtained.

In the aforementioned abrasive grain fixing process, the diamond abrasive grains 2 are embedded in a depth corresponding to about ⅔ of the average grain size thereof. Accordingly, the smaller the average grain size of the diamond abrasive grains 2 is, the smaller the average abrasive grain height Hc immediately after the abrasive grain fixing process is. Thus the smaller the average grain size is, the lapping rate becomes lower even in the initial state of the lapping process. Even when it is tried to increase the average abrasive grain height Hc using abrasive grains having a small average grain size, a sufficient abrasive grain holding force to the lapping plate 1 cannot be obtained. Thus it is difficult to obtain a stable abrasive grain density. As the abrasive grain density becomes extremely low, a load is concentrated on one abrasive grain and its cutting depth becomes deep in the lapping step and the surface roughness becomes large. To avoid this, the abrasive grain density is preferably such that 5 or more abrasive grains are fixed in 1 μm square, when observed with about a 10,000× magnification using a scanning electron microscope (SEM);

FIG. 2B is a schematic diagram for explaining a relationship between an average abrasive grain height and an abrasive grain height variation for the diamond abrasive grains 2 when the abrasive digging process is carried out after the abrasive grain fixing process. In the drawing, Hd denotes an average abrasive grain height of the diamond abrasive grains 2 after the abrasive digging process is carried out, and Vd denotes an abrasive grain height variation. Since the abrasive digging process causes the soft metal (tin, its alloy and so forth) surface of the lapping plate 1 to be mainly removed, the average abrasive grain height Hc of the diamond abrasive grains 2 shown in FIG. 2A is increased to Hd.

Meanwhile, if the soft metal surface removal from lapping plate 1 is uniform, the abrasive grain height variation Vd after the abrasive digging process is kept at about the same level as Vc as the case shown in FIG. 2A. On the other hand, if the soft metal surface removal from lapping plate 1 is not uniform, the abrasive grain height variation Vd becomes larger than the abrasive grain height variation Vc.

The average grain size of abrasive grains to be fixed in the lapping plate for use in the fine lapping of the air bearing surface of the magnetic head is usually about 100 nm. When such abrasive grains are fixed, its average abrasive grain height lies in a range of about between 20 and 40 nm. When such a size of abrasive grains are employed, in order to maintain the holding force of the abrasive grains, the lapping quantity of the metallic surface of the lapping plate by abrasive grain digging is preferably about 5 to 20 nm. However, it is actually difficult to evenly or uniformly process the surface of the lapping plate having the diamond abrasive grains 2 fixed therein accurately with a lapping quantity from several nm to tens of nm. For this reason, for the purpose of making the abrasive grain height variation smaller than Vc, an abrasive peak equalization process (to be explained later) becomes necessary.

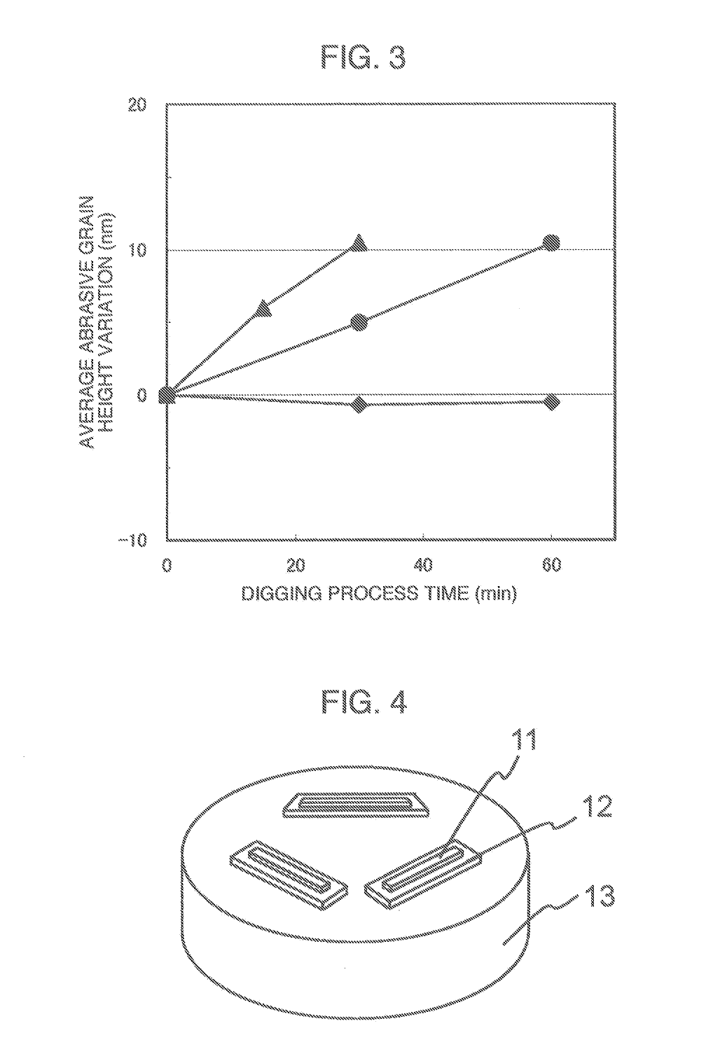

FIG. 3 shows a relationship between an abrasive grain digging time and a variation amount in an average abrasive grain height in the abrasive grain digging process. A soft metal lapping plate of tin having a diameter of 380 mm is used as the lapping plate, and rectangular grooves having a depth of 7 μm, a width of 20 μm and a pitch of 45 μm, are formed in the surface of the plate. Thereafter, a diamond slurry (manufactured by Engis Corporation) containing abrasive grains of an average grain diameter size of 80 nm is supplied on the surface of the lapping plate other than the grooves to fix the abrasive grains in the plate with use of a ceramic-made fixing tool.

In the abrasive digging process, a diamond slurry (manufactured by Engis Corporation) having abrasive grains of an average grain diameter size of 50 nm was supplied onto the rotating lapping plate, a lapping pad (manufactured by Engis Corporation; 530N) was bonded on the surface of a dressing tool of a doughnut shape having an outer diameter of 140 mm and a width of 10 mm, and the dressing tool was rotated and pushed against the surface of the lapping plate.

Here, the average abrasive grain height of the diamond abrasive grains 2 was defined as follows. That is, with respect to arbitrary locations (at least 10 locations, desirably 24 locations spaced by 45 degrees on inner, middle and outer peripheries) on the lapping plate 1, each 5 μm square area at the respective locations on the lapping plate 1 is measured with respect to surface shape with use of an atomic force microscope (AFM), 10 of measured heights of fixed abrasive grains at the respective measurement points are selected in a descending height order, an average value of the selected grain heights in all the areas is obtained, and the average value thus obtained is defined as an average abrasive grain height.

FIG. 3 shows results when the lapping pad pushing pressure is changed to about 2 times (mark : 0.8 kPa, mark ▴: 1.7 kPa) and when the pushing pressure is set at 1.7 kPa and the lapping lubricant 6 without the abrasive grains 5 is supplied. When the lapping lubricant 6 without the abrasive grains 5 is supplied, it will be seen from the graph that no increase in the average abrasive grain height is observed as the processing time increases, and a combination of the lapping lubricant without the abrasive grains and the lapping pad produces no abrasive grain digging effect, that is, no lapping of the metal surface of the lapping plate 1.

Meanwhile, when the diamond slurry with the abrasive grains 5 is supplied, the average abrasive grain height of the diamond abrasive grains 2 is increased nearly constantly as the processing time increases. And by increasing the pushing pressure of the lapping pad, the abrasive grain height of the diamond abrasive grains 2 can be increased in a short time. That is, adjustment of the processing time and the pushing pressure of the lapping pad enables control of the average abrasive grain height of the diamond abrasive grains 2.

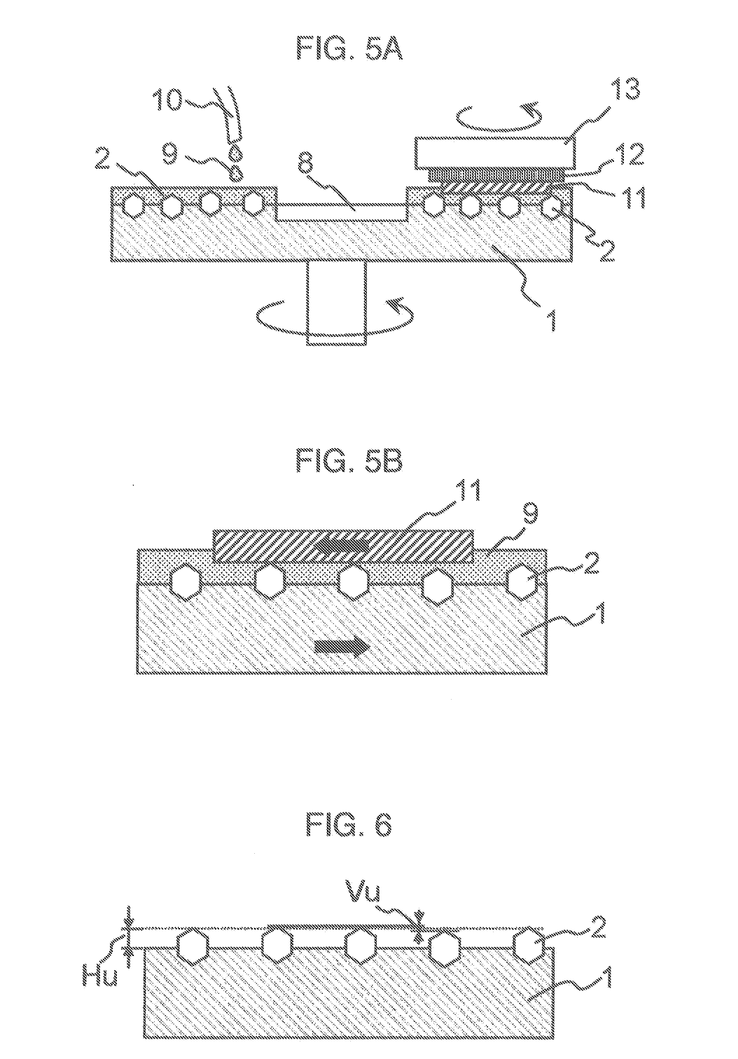

Explanation will next be made of the abrasive peak equalization process of the diamond abrasive grains 2 by referring to FIGS. 5 to 9.

FIG. 4 shows a schematic diagram of a conditioning tool used in the abrasive peak equalization process of the diamond abrasive grains 2. A plurality of ceramic substrates 11 are bonded on the surface of a conditioning tool 13 each with an elastic member 12 disposed therebetween. In the abrasive peak equalization process, the ceramic substrates 11 are positioned to be opposed to the surface of the lapping pad. The pushing pressure is calculated on the basis of the mass of the conditioning tool 13 and the total surface area of the ceramic substrates 11 and the pushing pressure is adjusted as necessary.

FIGS. 5A and 5B show schematic diagrams for explaining the abrasive peak equalization process of the diamond abrasive grains 2. More specifically, FIG. 5A is a schematic diagram of an entire processing apparatus for the equalization process, and FIG. 5B is a partial enlargement of the apparatus showing a relationship between the lapping plate 1 and the ceramic substrate 11. In FIG. 5A, a lapping lubricant 9 without abrasive grains is supplied from a supply tube 10 onto the surface of the lapping plate while the lapping plate 1 already subjected to the aforementioned abrasive digging process is being rotated; and the conditioning tool 13 is rotated to push the ceramic substrates 11 held to the adhesive elastic members 12 against the surface of the lapping plate 1 having the diamond abrasive grains 2 fixed therein. The present invention is not restricted to use of the ceramic substrate but any material capable of providing the similar effect can be employed in the invention.

In FIG. 5B, a distance (gap) between the ceramic substrates 11 and the surface of the lapping plate 1 is determined by the pushing pressure of the ceramic substrates 11 and the physical properties of the lapping lubricant 9 without abrasive grains. By adjusting the pushing pressure of the ceramic substrates 11, the gap is made relatively large, the abrasive grain height of the diamond abrasive grains 2 is made large so that the diamond abrasive grains 2 protruded from the surface of the lapping plate 1 are selectively indented. As a result, a decrease in the average abrasive grain height of the diamond abrasive grains 2 becomes small and a lapping plate having a small abrasive grain height variation is achieved.

For example, when a dynamic viscosity of the lapping lubricant 9 without abrasive grains is adjusted at 1.8×10⁻⁶ m²/s and the pushing pressure of the ceramic substrates 11 is set at about 150 kPa; an average abrasive grain height of the diamond abrasive grains 2 after the abrasive peak equalization process becomes about 27 nm. When the pushing pressure of the ceramic substrates 11 is increased to about 255 kPa, an average abrasive grain height of the diamond abrasive grains 2 becomes about 19 nm. Accordingly, when the lapping lubricant 9 without abrasive grains is same, an average abrasive grain height of the diamond abrasive grains 2 after the abrasive peak equalization process can be adjusted by adjusting the pushing pressure of the ceramic substrates 11.

When processing carried out with the gap between the ceramic substrates 11 and the surface of the lapping plate 1 kept constant, the gap causes abrasive grains having larger abrasive grain heights than the gap to be indented into the surface of the lapping plate 1, and when the abrasive grain heights becomes the same as the gap, the grain indentation is stopped. As a result, the abrasive grain height variation of the diamond abrasive grains 2 can be reduced.

When the average abrasive grain height of the diamond abrasive grains 2 is high, a high lapping rate can be obtained with a small lapping pressure. Accordingly, in the abrasive peak equalization process, it is preferable to carry out the abrasive peak equalization process under the condition that a decrease in the average abrasive grain height of the diamond abrasive grains 2 after the abrasive digging process be made as small as possible.

FIG. 6 is a schematic diagram for explaining a relationship between an abrasive grain height and an abrasive grain height variation for the diamond abrasive grains 2 after the abrasive peak equalization process. In the drawing, Hu denotes an average abrasive grain height for the diamond abrasive grains 2 after the abrasive peak equalization process and Vu denotes an abrasive grain height variation. The decrease in the average abrasive grain height Hu remains somewhat small as compared with the average abrasive grain height Hd after the abrasive digging process shown in FIG. 2B, and the abrasive grain height variation Vu is decreased as compared with the abrasive grain height variation Vd after the abrasive digging process.

As has been explained above, when the abrasive digging process and the abrasive peak equalization process are carried out continuously, there can be obtained a lapping plate which has a large average abrasive grain height for the diamond abrasive grains 2 as compared with conventional general lapping plates having no such processes, and which also has an improved abrasive grain height variation.

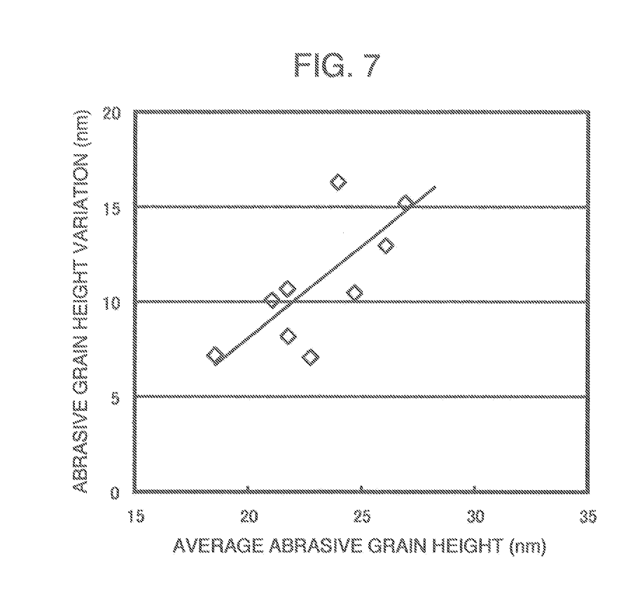

FIG. 7 shows a relationship between an average abrasive grain height and an abrasive grain height variation for a lapping plate having abrasive grains fixed therein in a conventional manner. The same lapping plate and members as those shown in FIG. 3 are used in the abrasive grain fixing process. The drawing shows a result when two lapping plates are manufactured under identical conditions and an average abrasive grain height and an abrasive grain height variation are measured several times while the lapping rate is being reduced during lapping of a row bar.

As will be clear from the drawing, when an average abrasive grain height for the diamond abrasive grains 2 is large, its abrasive grain height variation is also large, and as the average abrasive grain height is decreased, the abrasive grain height variation is also decreased. This means that, as the lapping operation proceeds or the lapping frequency increases, the row bar as a processing target object causes the diamond abrasive grains 2 protruded from the surface of the lapping plate to be indented into the plate and the entire abrasive grains to be also pressed down. In other words, in the conventional abrasive grain fixing process and in a lapping method using the lapping plate made by the conventional fixing process, the abrasive grain height variation is decreased with sinking of the abrasive grains. As a result, it is difficult to obtain a lapping plate which can be used in industrial applications (i.e., the lapping plate that has a larger average abrasive grain height and a small abrasive grain height variation for abrasive grains).

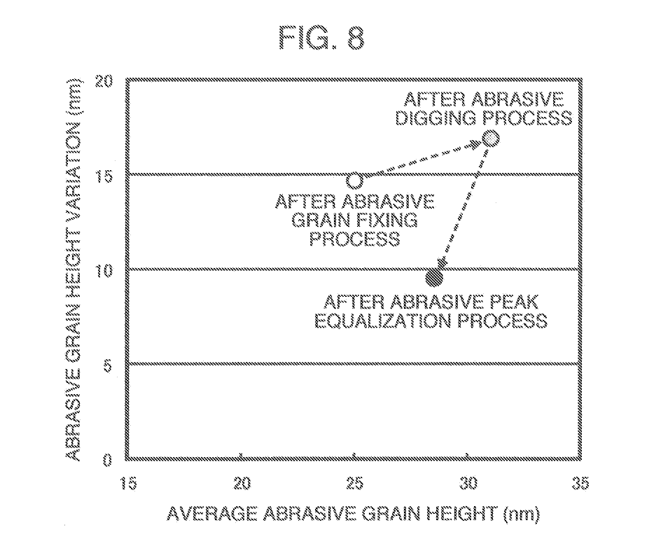

FIG. 8 shows a result when an average abrasive grain height and an abrasive grain height variation are measured in respective processes for the lapping plate which is subjected to a conventional abrasive grain fixing process to have abrasive grains fixed therein and which is then subjected to the abrasive digging process and the abrasive peak equalization process. The lapping plate and members used in the abrasive grain fixing process and the abrasive digging process were the same as those shown in FIG. 3. The abrasive digging process was carried out under the conditions that a processing time is 30 minutes under a pushing pressure of a lapping plate of 0.8 kPa so that an average abrasive grain height is increased by about 5 nm. The abrasive peak equalization process was carried out under the following conditions. That is, while lapping lubricant (hydrocarbon-based lubricant oil) without abrasive grains is supplied to the surface of the lapping plate after the abrasive digging process, and while a conditioning tool of an outer diameter of 140 mm having 3 row bars of 50 mm×1 mm×0.23 mm held thereto with an adhesive polyurethane sheet disposed therebetween is rotated, the conditioning tool was pushed against the lapping plate at a pressure of 149 kPa for 20 minutes.

As will be seen from the result shown in FIG. 8, as compared with the result after the abrasive grain fixing process (conventional general process), the abrasive digging process causes the average abrasive grain height for the diamond abrasive grains 2 to be increased by about 6.0 nm, and the subsequent abrasive peak equalization process therefor causes the average abrasive grain height for the diamond abrasive grains 2 to be decreased by about 2.5 nm and the abrasive grain height variation to be decreased by about 7.5 nm. The lapping plate immediately after the abrasive grain fixing process had an average abrasive grain height of about 25.0 nm and an abrasive grain height variation of about 14.8 nm for the diamond abrasive grains 2. However, after such a lapping plate was subjected to the abrasive digging process and the abrasive peak equalization process, the average abrasive grain height was about 28.5 nm and the abrasive grain height variation was about 9.5 nm. As a result, the lapping rate was increased and lapping with an excellent flatness of the lapping surface was able to be obtained.

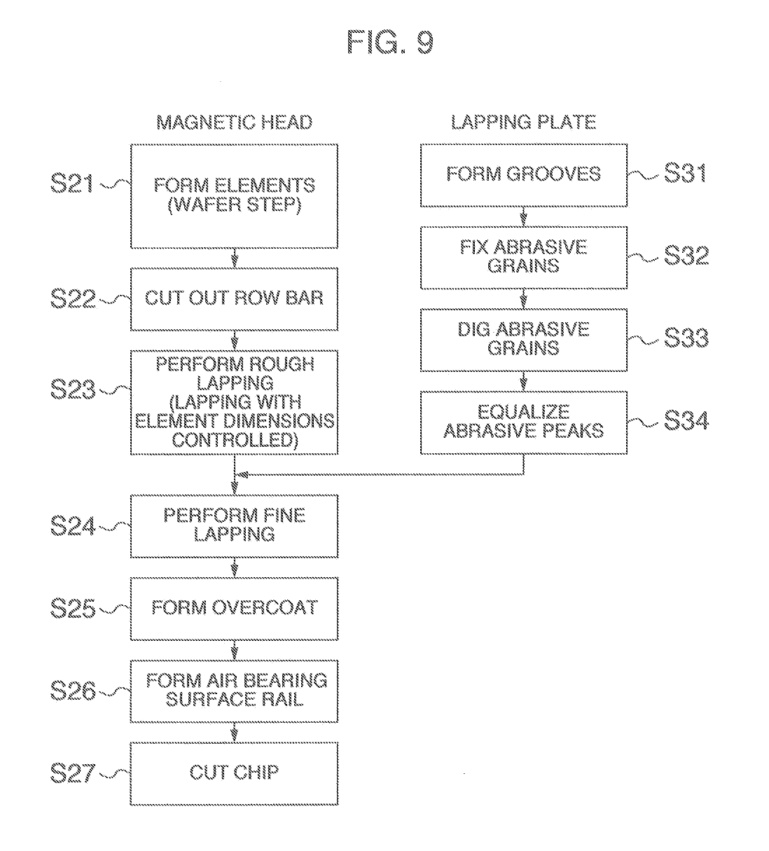

Explanation will next be made as to a method of manufacturing a thin film magnetic head using a lapping plate manufactured in the aforementioned new method, by referring to FIG. 9. An insulating layer of a thickness of 2-10 μm and of Al₂O₃ (alumina) or the like, a magnetic write/read element layer having magnetic write/read elements, and an overcoat of a thickness of about 50 μm and of Al₂O₃ (alumina) or the like, are formed by a thin film forming process on a wafer (substrate) of Al₂O₃—TiC (alumina titanium carbide) or the like and of a size of 4-6 inches (step S21). Subsequently, a row bar having a length of about 2 inches is cut off from the substrate using a dicer or the like (step S22). Next, while a lapping slurry with abrasive grains of diamond or the like is dropped on the surface of the rotating soft-metal-based lapping plate, the air bearing surface of the row bar fixed to the lapping tool is pushed, slid and lapped against the lapping plate. Or while a lapping lubricant without abrasive grains is dropped on a lapping plate having abrasive grains fixed therein, the size of the fixed grains being larger than that of abrasive grains for use in the next fine lapping step; similar lapping treatment to the above is carried out. At this time, such control is carried out so that that the dimensions of a magnetic resistance element lies within a specified range by detecting the resistances of the magnetic write/read elements or by detecting the resistance of ELG (electric lapping guide) element in the row bar (step S23).

The air bearing surface of the row bar is then subjected (step S24) to fine lapping treatment with use of the lapping plate already subjected to the groove forming process (step S31), the abrasive grain fixing process (step S32), the abrasive digging process (step S33) and the abrasive peak equalization process (step S34).

Next, after an overcoat such as a DLC (Diamond-Like-Carbon) film is formed on the air hearing surface of the lapped row bar (step S25), an air bearing surface rail is formed thereon by ion milling or by a similar process (step S26). And individual small pieces (sliders) containing magnetic write/read elements are cut of by dicing, wire sawing or the like from the row bar (step S27) to complete a magnetic head.

Although the process of manufacturing the magnetic head and the process of manufacturing the lapping plate are together given in a process chart of FIG. 9 to show how to manufacture the magnetic head using both of the head and plate manufacturing processes, the process of manufacturing the lapping plate may be given separately from the process of manufacturing the magnetic head. In short, any lapping plate can be employed so long as the lapping plate for use in the fine lapping step (step S24) of the process of manufacturing the magnetic head is manufactured in accordance with a procedure shown in the process of manufacturing the magnetic head.

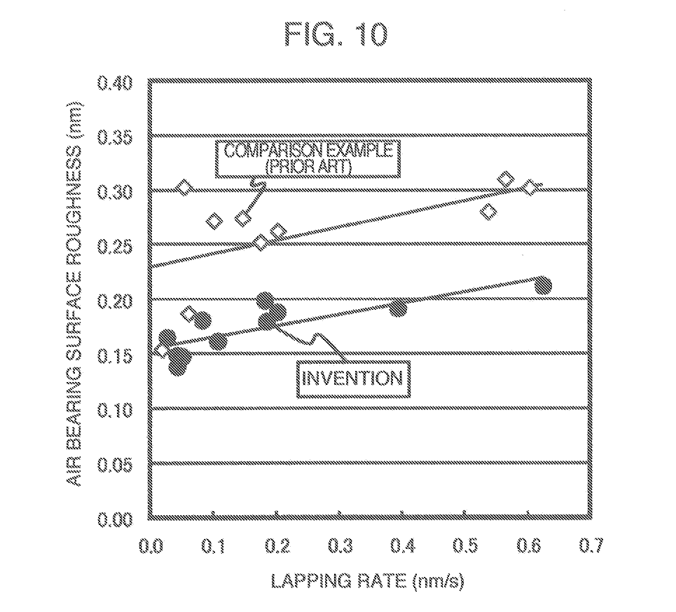

FIG. 10 (refer to marks ) shows a relationship between the surface roughness of the air bearing surface of a magnetic head manufactured in accordance with the manufacturing procedure of FIG. 9 and a lapping rate thereof. Marks ⋄ are also given for a magnetic head manufactured by a conventional method not carrying out the inventive processes (the abrasive digging process and the abrasive peak equalization process) as shown in FIG. 10.

In the case of FIG. 10, the lapping plate and members used in the abrasive grain fixing process, the abrasive digging process and the abrasive peak equalization process were the same as those used in FIG. 8. In this connection, the lapping rate was measured such that the resistance of the ELG element provided to the row bar was measured at 20 locations within the row bar before and after the lapping, and the lapping rate was calculated on the basis of a change in the measured resistance and a lapping time. The lapping was carried out under constant conditions of a lapping pressure of 160 kPa so that an average lapping quantity of dimensions of the read elements is 5 nm.

The surface roughness of the air bearing surface was measured using an atomic force microscope with respect to a 5 μm range having the read element of the air bearing surface as its center to find a calculated average roughness Ra in a range of a width of about 5 μm and of height of 1 μm in the vicinity of the read element, and the roughness Ra was used as the surface roughness of the air bearing surface.

As will be obvious from FIG. 10, the roughness of the air bearing surface can be generally more reduced regardless of the magnitude of the lapping rate in the case where the lapping plate subjected to the abrasive digging process and the abrasive peak equalization process was used for the processing (refer to marks ) as compared with the case where the lapping plate having abrasive grains fixed therein by the conventional method was used for the processing (refer to marks ⋄). This clearly represents the states of abrasive grains on the lapping plate shown by the prior art method (marks ∘) and by the present invention method (marks ) in FIG. 8.

As has been explained above, when the grain-fixed lapping plate further subjected to the abrasive digging process and the abrasive peak equalization process is used, there can be efficiently manufactured a magnetic head element which has a highly flat air hearing surface.

It should be further understood by those skilled in the art that although the foregoing description has been made on embodiments of the invention, the invention is not limited thereto and various changes and modifications may be made without departing from the spirit of the invention and the scope of the appended claims.

1. A method of manufacturing a lapping plate for use in lapping of a surface of a substrate, comprising the steps of:
pushing first abrasive grains against a metal surface of the lapping plate and fixing the first abrasive grains in the plate;
supplying a slurry with second abrasive grains onto the metal surface of the lapping plate having the first abrasive grains fixed therein; and
subjecting the metal surface of the lapping plate in the vicinity of the first abrasive grains to an abrasive digging process with use of an elastic member having an irregular surface.

2. A method of manufacturing a lapping plate according to claim 1, wherein an abrasive grain height processing step of equalizing abrasive grain heights of the first abrasive grains is carried out after the abrasive digging process of the first abrasive grains.

3. A method of manufacturing a lapping plate according to claim 1, wherein an average grain size of the second abrasive grains is equal to or not larger than an average grain size of the first abrasive grains.

4. A method of manufacturing a lapping plate according to claim 1, wherein the first abrasive grains are abrasive grains of diamond, and the second abrasive grains are abrasive grains of one selected from a group of diamond, silicon carbide and alumina or of a mixture thereof.

5. A method of manufacturing a lapping plate according to claim 1, wherein the elastic member is a member of a material selected from a group of urethane-contained unwoven cloth, foamed polyurethane and suede.

6. A method of manufacturing a lapping plate according to claim 2, wherein the abrasive grain height processing step is carried out by pushing a ceramic plate against the first abrasive grains.

7. A method of manufacturing a magnetic head comprising the steps of
forming a plurality of magnetic write elements, a plurality of magnetic read elements and an overcoat on a substrate;
cutting the substrate into strip pieces;
lapping a surface of each of the strip pieces to form an air bearing surface; and
cutting out a magnetic head including the magnetic write/read elements from the strip piece,
wherein the step of forming the air bearing surface is carried out by pushing the air bearing surface against the lapping plate subjected to digging process of the abrasive grains fixed in the lapping plate and to an abrasive peak equalization process of the abrasive grains for lapping.
